(19) United States
(12) Patent Application Publication
(10) Pub. No.: US 2026/0035131 A1
(43) Pub. Date: Feb. 5, 2026

(54) PACKAGING CONSTRUCT WITH LINER

(71) Applicant: Graphic Packaging International, LLC, Atlanta, GA (US)

(72) Inventors: Tom Garsed, Sutton Coldfield (GB); Jamie Skipper, Leicester (GB); Elliot Hithersay, Derbyshire (GB)

(21) Appl. No.: 19/288,025

(22) Filed: Aug. 1, 2025

Related U.S. Application Data
(60) Provisional application No. 63/678,706, filed on Aug. 2, 2024.

(51) Int. Cl. B65D 5/56; B31B 50/25; B31B 50/26; B31B 50/60; B31B 50/81; B31B 100/00; B31B 110/30; B31B 120/10; B65D 5/54; B65D 5/64

(52) U.S. Cl. CPC B65D 5/566; B31B 50/25; B31B 50/26; B31B 50/60; B31B 50/814; B65D 5/5495; B65D 5/64; B31B 2100/0024; B31B 2110/30; B31B 2120/10

(57) ABSTRACT

A packaging construct includes a panel having a first surface and an opposing second surface, at least a layer of material extending along the second surface of the construct, a first partial cut at least partially extending into the panel from the first surface, and a second partial cut extending through the layer of material and into the second surface of the panel, the first partial cut and the second partial cut cooperate to at least partially form a separation feature in the construct for facilitating separation between portions of the construct.

### CROSS-REFERENCE TO RELATED APPLICATION

The present application claims priority to U.S. Provisional Patent Application No. 63/678,706, filed on Aug. 2, 2024.

### INCORPORATION BY REFERENCE

The disclosures of U.S. Provisional Patent Application No. 63/678,706, filed on Aug. 2, 2024, U.S. Provisional Patent Application No. 63/543,560, filed Oct. 11, 2023, U.S. Provisional Patent Application No. 63/533,393, filed Aug. 18, 2023, U.S. patent application Ser. No. 16/037,425, filed Jul. 17, 2018, U.S. patent application Ser. No. 15/654,814, filed Jul. 20, 2017, and U.S. patent application Ser. No. 12/992,131, filed Feb. 11, 2011, are hereby incorporated by reference for all purposes as if presented herein in their entirety.

### BACKGROUND OF THE DISCLOSURE

The present disclosure relates to blanks, containers, trays, constructs, and various features and methods for forming a container and/or a package from one or more constructs and/or other materials. More specifically, the disclosure is generally directed to a package having a liner and/or a lid and separation features for facilitating separation between portions of the package.

### SUMMARY OF THE DISCLOSURE

According to one aspect, the disclosure is generally directed to a packaging construct, the packaging construct comprising a panel comprising a first surface and an opposing second surface, at least a layer of material extending along the second surface of the construct, a first partial cut at least partially extending into the panel from the first surface, and a second partial cut extending through the layer of material and into the second surface of the panel, the first partial cut and the second partial cut cooperate to at least partially form a separation feature in the construct for facilitating separation between portions of the construct.

According to another aspect, the disclosure is generally directed to a package, the package comprising a crown, the crown comprising a plurality of separably connected flange panels, each flange panel extending at least partially around an opening, the crown further comprising a plurality of end flaps foldably connected to the respective flange panel and extending into the respective opening, a plurality of bottom constructs attached to a respective flange panel of the crown to form a base layer, each bottom construct comprising a bottom panel and a plurality of side panels foldably connected to the bottom panel and extending at least partially around an interior of the bottom construct, respective end flaps of the crown attached to respective side panels of the respective bottom construct, and a liner at least partially overlying the flange panels and the bottom constructs, the liner extending along a second surface of a pair of flange panels of the plurality of flange panels, the second surface opposite an upper surface of the pair of flange panels, a first partial cut extends into the pair of flange panels from the first surface and a second partial cut extends through the liner and into the second surface of the pair of flange panels from the second surface, the first partial cut and the second partial cut cooperate to at least partially form a separation feature in the flange panels for facilitating separation between portions of the package.

According to another aspect, the disclosure is generally directed to a method of forming a package, the method comprising obtaining a crown blank, the crown blank comprising a plurality of separably connected flange panels, each flange panel extending at least partially around an opening, the crown further comprising a plurality of end flaps foldably connected to the respective flange panel and extending into the respective opening, obtaining a bottom blank, the bottom blank comprising a bottom panel and a plurality of side panels foldably connected to the bottom panel, obtaining a liner, forming a crown from the crown blank, forming a plurality of bottom constructs from the bottom blank such that the plurality of side panels extends at least partially around an interior of the respective bottom construct, attaching respective end flaps of the crown to respective side panels of a respective bottom construct to form a base layer, at least partially overlying the liner on the flange panels and the bottom constructs such that the liner extends along a second surface of a pair of flange panels of the plurality of flange panels, the second surface opposite an upper surface of the pair of flange panels, forming a first partial cut extending into the pair of flange panels from the first surface, forming a second partial cut extending through the liner and into the second surface of the pair of flange panels from the second surface, the first partial cut and the second partial cut cooperate to at least partially form a separation feature in the flange panels for facilitating separation between portions of the package.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of a blank or other construct used for forming at least a portion of a package according to exemplary embodiments of the disclosure.

FIGS. 2-3 are sequential schematic cross-sectional views of a portion of a package including the construct of FIG. 1 showing the formation of a separation feature of the package according to exemplary embodiments of the disclosure.

FIG. 4 is a plan view of a crown blank for forming a package with a plurality of sections or pots according to an exemplary embodiment of the disclosure.

FIG. 5 is a plan view of a bottom blank for at least partially forming a package with a plurality of sections or pots according to an exemplary embodiment of the disclosure.

FIG. 6 is a plan view of liner material for at least partially forming a package with a plurality of sections or pots according to an exemplary embodiment of the disclosure.

FIG. 7 is a plan view of a lidding material for at least partially forming a package with a plurality of sections or pots according to an exemplary embodiment of the disclosure.

FIG. 8 is a first sequential perspective view of a formation of a package with a plurality of sections or pots from the crown blank of FIG. 4, the bottom blank of FIG. 5, the liner material of FIG. 6, and the lidding material of FIG. 7 according to an exemplary embodiment of the disclosure.

FIG. 9 is a second sequential perspective view of a formation of a package with a plurality of sections or pots from the crown blank of FIG. 4, the bottom blank of FIG. 5, the liner material of FIG. 6, and the lidding material of FIG. 7 according to an exemplary embodiment of the disclosure.

FIG. 10 is a third sequential perspective view of a formation of a package with a plurality of sections or pots from the crown blank of FIG. 4, the bottom blank of FIG. 5, the liner material of FIG. 6, and the lidding material of FIG. 7 according to an exemplary embodiment of the disclosure.

FIG. 11 is a fourth sequential perspective view of a formation of a package with a plurality of sections or pots from the crown blank of FIG. 4, the bottom blank of FIG. 5, the liner material of FIG. 6, and the lidding material of FIG. 7 according to an exemplary embodiment of the disclosure.

FIG. 12 is a fifth sequential perspective view of a formation of a package with a plurality of sections or pots from the crown blank of FIG. 4, the bottom blank of FIG. 5, the liner material of FIG. 6, and the lidding material of FIG. 7 according to an exemplary embodiment of the disclosure.

FIG. 13 is a sixth sequential perspective view of a formation of a package with a plurality of sections or pots from the crown blank of FIG. 4, the bottom blank of FIG. 5, the liner material of FIG. 6, and the lidding material of FIG. 7 according to an exemplary embodiment of the disclosure.

FIG. 14 is a seventh sequential perspective view of a formation of a package with a plurality of sections or pots from the crown blank of FIG. 4, the bottom blank of FIG. 5, the liner material of FIG. 6, and the lidding material of FIG. 7 according to an exemplary embodiment of the disclosure.

FIG. 15 is a perspective view showing separation of a section or pot of the package shown in FIG. 14 according to an exemplary embodiment of the disclosure.

Corresponding parts are designated by corresponding reference numbers throughout the drawings.

### DETAILED DESCRIPTION OF THE EXEMPLARY EMBODIMENTS

The present disclosure relates generally to various aspects of containers, constructs, trays, materials, packages, elements, and articles, and methods of making such containers, constructs, trays, materials, packages, elements, and articles. Although several different aspects, implementations, and embodiments are disclosed, numerous interrelationships between, combinations thereof, and modifications of the various aspects, implementations, and embodiments are contemplated hereby. In embodiments, the present disclosure relates to forming a package with one or more containers or trays for holding food items or various other articles. However, in other embodiments, the container or tray can be used to form other non-food containing articles or may be used for heating or cooking. In this specification, the terms “inner,” “interior,” “outer,” “exterior,” “lower,” “bottom,” “upper,” and “top” indicate orientations determined in relation to fully erected and upright packages. As described herein, constructs can be formed from blanks and/or other constructs with multiple panels, portions, tabs, flaps, sections, lines of weakening, openings, apertures, and/or other aspects, which may be designated herein in terms relative to one another, e.g., “first”, “second”, “third”, etc., in sequential or nonsequential reference, without departing from the disclosure.

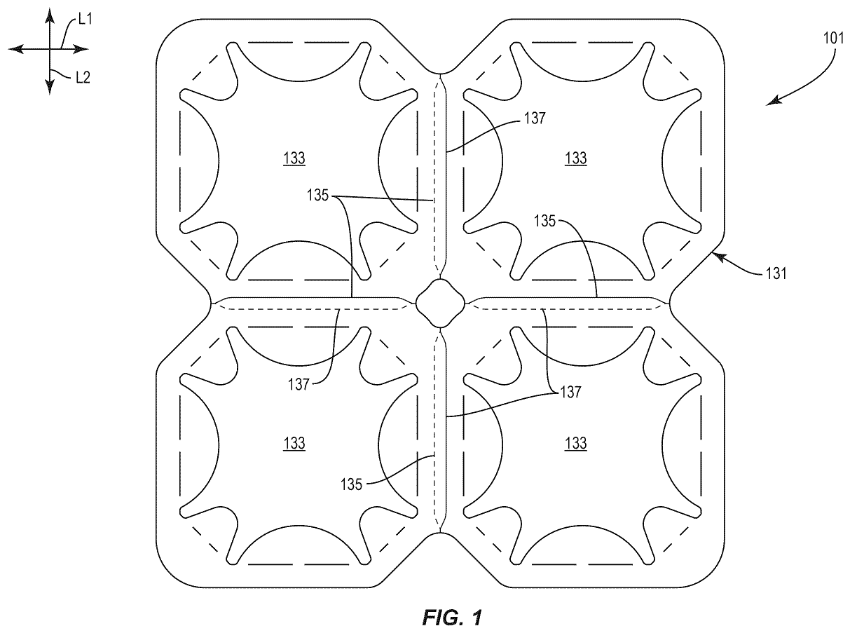

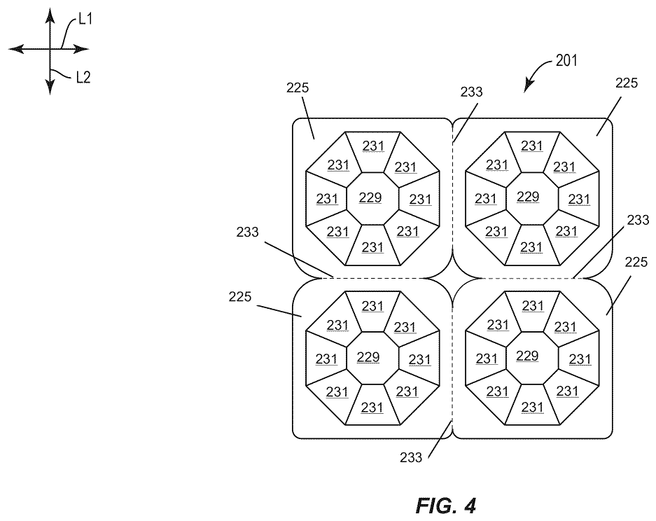

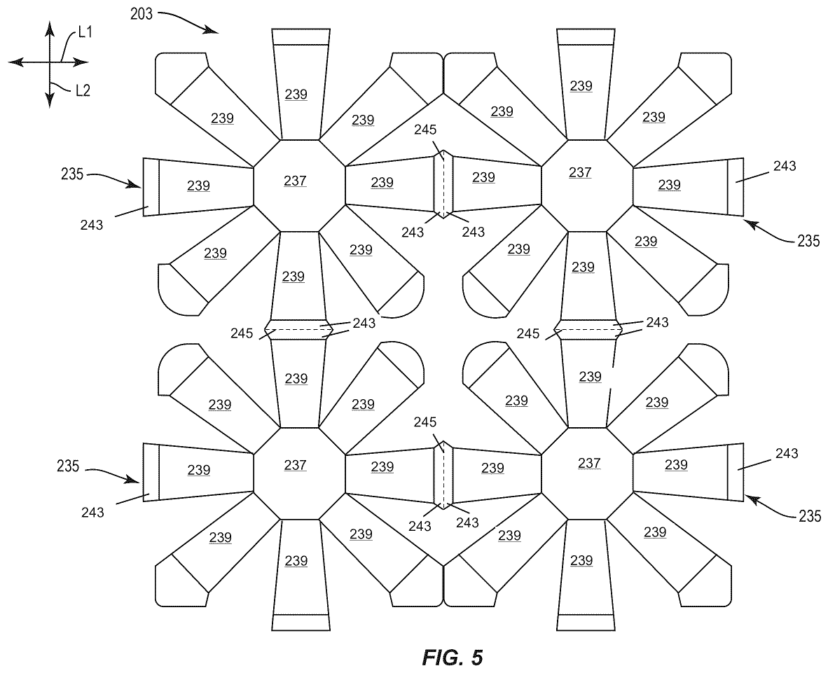

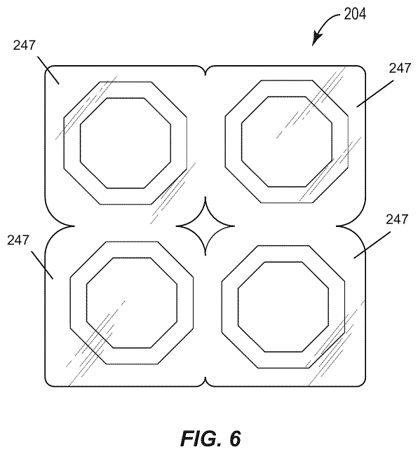

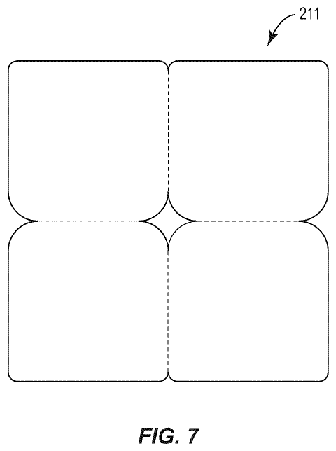

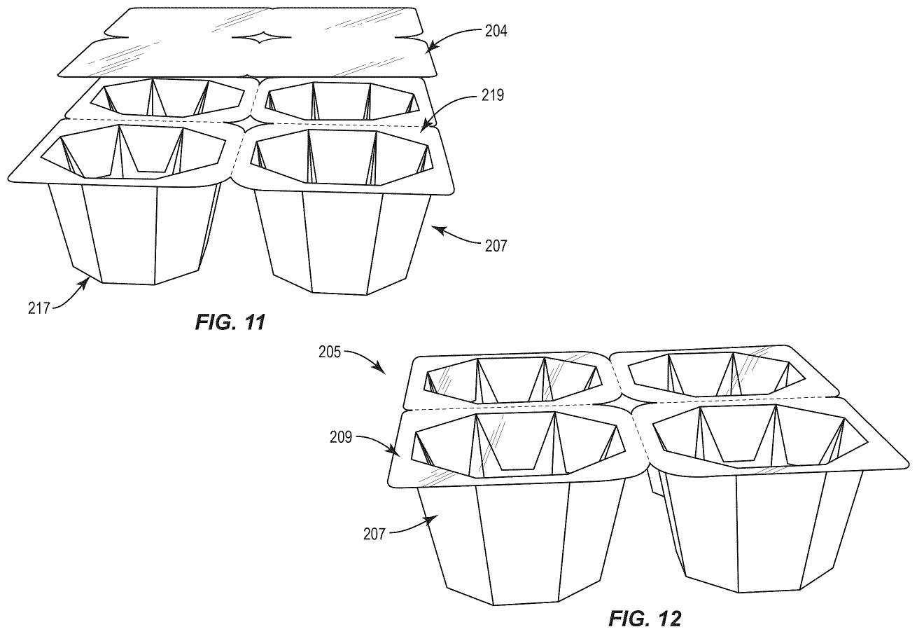

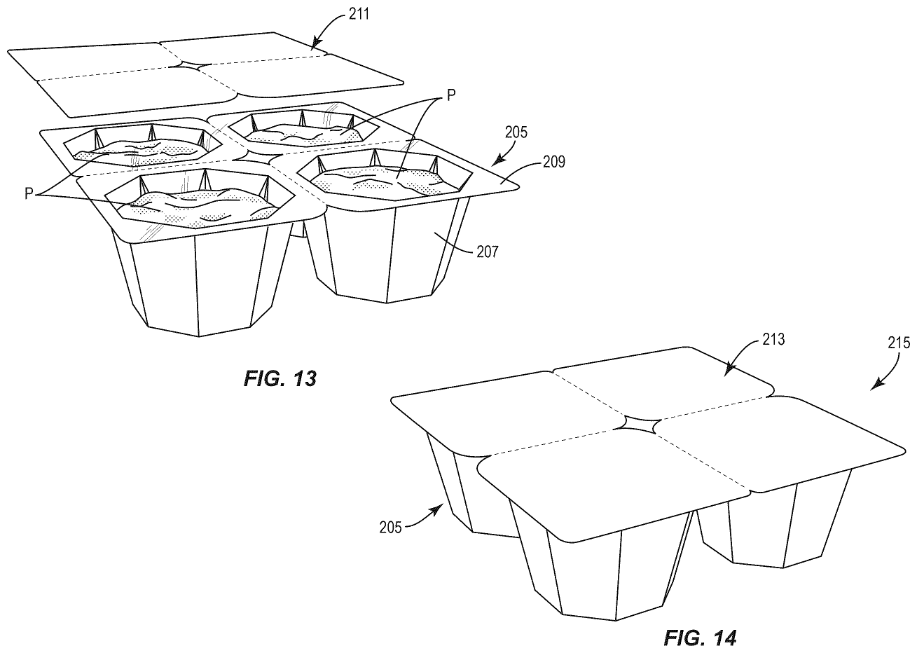

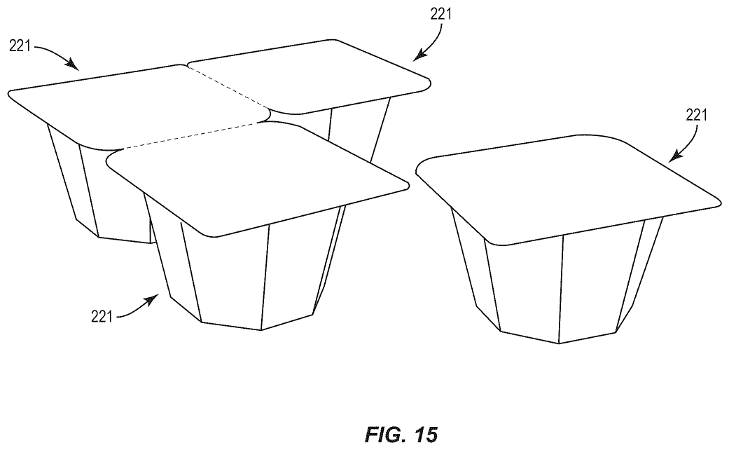

FIG. 1 illustrates a plan view of a construct 101, which can be in the form of a crown blank, such as a crown blank 201 of a package 215 (e.g., FIG. 14) according to exemplary embodiments of the disclosure. In embodiments, the construct or crown blank 201 (FIG. 4) can cooperate with a bottom blank 203 (FIG. 5) and a liner material 204 (FIG. 6) to at least partially form a container 205 (FIG. 12) with multiple compartments (e.g., which can be considered a plurality of containers or trays sharing a common crown). In the illustrated embodiments, the crown blank 201 and the bottom blank 203 can cooperate to at least partially form a base layer 207 (FIG. 11) of the container 205 and the liner material 204 can at least partially form a liner 209 of the container 205. As shown in FIG. 13, the container 205 can be filled with a product P (e.g., a food product and/or other suitable product), and a lidding material 211 (FIG. 7) can be applied over the container 205 to at least partially form a lid 213 (FIG. 14) that is attached to the crown of the container 205, enclosing the product in the compartments. In the illustrated embodiments, the filled container 205 and the lid 213 can cooperate to at least partially form a package 215 (FIG. 12).

As shown in FIG. 4, the crown blank 201 can have the longitudinal axis L1, the lateral axis L2, and can include a plurality of flange panels 225 separably connected to one another at a respective line of weakening 227 that can be laterally or longitudinally oriented.

Each flange panel 225 can extend at least partially around a respective central opening 229, and plurality of attachment end flaps 231 can be foldably connected to the respective flange panel 225 at a respective fold line 233 that can be laterally, longitudinally, or obliquely oriented, the attachment flaps 231 positioned extending into the respective opening 229. Adjacent attachment flaps 231 can be separable from one another at a respective oblique cut. As shown, respective flange panels 225 can be at least partially separable from one another at respective lateral or longitudinal lines of weakening 234.

With reference to FIG. 5, the bottom blank 203 can have the longitudinal axis L1, the lateral axis L2, and a plurality of bottom blank sections 235 each including a respective bottom panel 237 and a plurality of side panels 239 that can be laterally, longitudinally, or obliquely oriented relative to the bottom panel 237 and foldably connected thereto at a respective fold line 241 that can be laterally, longitudinally, or obliquely oriented.

A plurality of end flaps 243 can be foldably connected to the respective side panel 239 at a respective fold line 245 that can be laterally, longitudinally, or obliquely oriented.

Respective adjacent end flaps 243 of respective bottom blank sections 235 can be separably connected at a line of weakening 245 that can be laterally or longitudinally oriented, as shown.

Turning to FIG. 6, the liner material 204 can have the longitudinal axis L1, the lateral axis L2, and a plurality of liner sections 247 that can include an embossed region 249 or other region at least partially formed by a series of lines of weakening. In some embodiments, the region 249 can have a generally octagonal configuration, though a different configuration could be provided without departing from the disclosure. In some embodiments, the liner sections 247 can be at least partially separable from one another at respective lines of weakening.

With reference to FIG. 7, the lidding material 211 can have the longitudinal axis L1, the lateral axis L2, and a plurality of lid sections 249 separably connected to one another at a respective line of weakening 251 that can be longitudinally or laterally oriented.

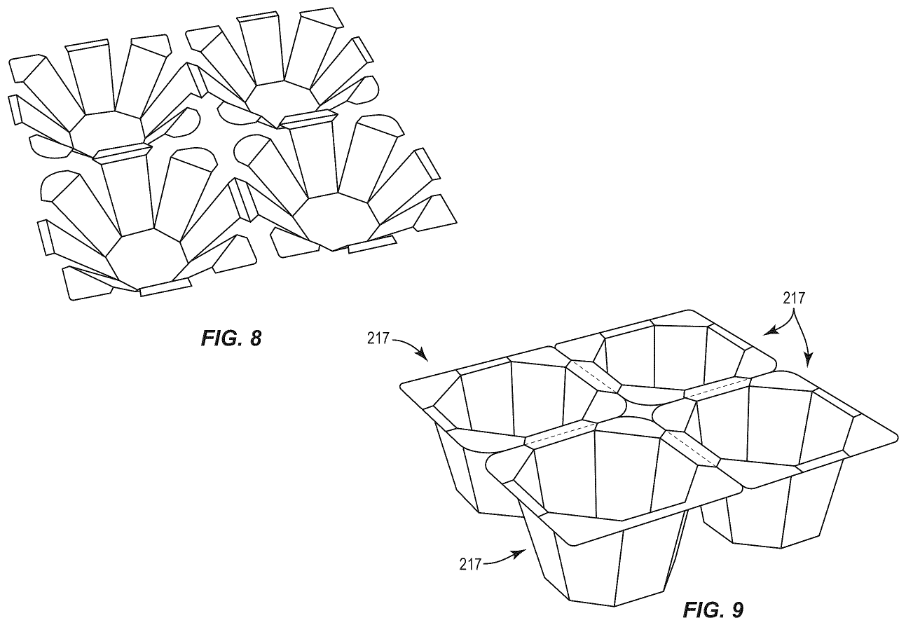

In the illustrated embodiments, the package 205 can be formed from the blanks 201, 203, the liner material 204, and the lidding material 211 as shown in FIGS. 8-14, for example. In exemplary embodiments, the side panels 239 of the bottom blank 203 can be folded upwardly at the respective fold lines 241 to form respective sidewalls thereof, and the respective end flaps 243 can be folded outwardly from the respective side panels 239 (e.g., away from the bottom panels 237) to form bottom constructs 217 as shown in FIG. 9, wherein the bottom constructs 217 are arranged in close proximity to one another.

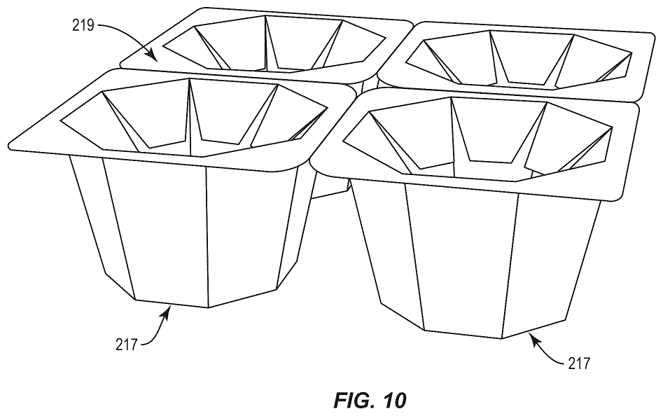

In embodiments, flange portions 253 of the bottom constructs 217 formed by the arrangement of the end flaps 243 can be spaced apart by approximately 1 millimeter. Alternatively, the flange portions of the bottom constructs could be abutting one another or could be spaced apart by any suitable distance. As shown in FIGS. 8-10, the crown blank 201 can be moved over the bottom constructs 217 (e.g., so that the flange panels 225 of the crown blank 201 overlap the flange portions 253 of the bottom constructs 217) and the attachment end flaps 231 of the crown blank 201 can be folded downwardly at the respective fold lines 233 to at least partially overlap the side panels 239 of the bottom constructs 217. As shown in FIG. 10, the crown blank 201 has been formed into a crown 219 overlapping the bottom constructs 217 to form the base layer 207. In some embodiments, the crown 219 and the bottom constructs 217 could be at least partially attached (e.g., adhered) together to form the base layer 207.

As shown in FIGS. 11 and 12, the liner material 204 can be moved over the base layer 207 and moved into the interiors of the compartments (e.g., with heat, air pressure, vacuum pressure, a plunger, and/or other suitable features) so that the liner 209 is sealed against the upper surface of the flange portions 253 and along the interior surfaces of the compartments, at least partially holding the crown 219 and the bottom constructs 217 together and forming the container 205 (e.g., a multipack tray).

As shown in FIGS. 13 and 14, the product P can be inserted into the interiors of the compartments of the container 205 and the lidding material 211 can be moved over the container 205. In embodiments, the lidding material 211 can be sealed (e.g., adhered, heat sealed, and/or otherwise attached/secured) to the flange portions 253 of the container 205 to form the lid 213 at least partially closing the compartments. The exemplary package 215 is shown in FIG. 14.

With additional reference to FIG. 15, the package 215 can include features for allowing individual pots or sections 221 of the package 215 (e.g., each section 221 including a respective bottom construct 217, liner portion 247, and lid portion 249) to be selectively removed from a remainder of the package 215 (e.g., while the product P remains sealed in the separated pots 221).

In embodiments, the separation features can be optimized snap features that can allow for an easy separation of the pots 221 while reducing or eliminating fiber tear and film overhang at the separation lines (e.g., providing a clean separation for a user). In exemplary embodiments, the separation features can include a plurality of first partial cuts, scores, and/or other suitable lines of weakening formed in an underside of the crown 219 (e.g., in an underside of the flange panels 225 of the crown 219) and a plurality of second partial cuts, scores, and/or other suitable lines of weakening formed in the lid 213, the liner 209, and the upper side of the crown 219 (e.g., along a portion of the flange of the package 215). In embodiments, the first partial cuts and the second partial cuts are offset from one another by a suitable distance in the plane of the flange of the package 215 so that the pots 221 remain connected at the flange portions 253 and can be separated easily and cleanly when desired by a user by selectively tearing along the offset partial cuts. In some embodiments, the first partial cuts, scores, and/or other suitable lines of weaking and the plurality of second partial cuts, scores, and/or other suitable lines of weakening can include one or more of the lines of weakening 234, 245, and 251.

For example, as shown in FIG. 1, the construct 101 (e.g., comprising paperboard and/or any other suitable material, and which can optionally have the configuration of the crown blank 201) can include flange panels 131 (comprising paperboard) extending between and around respective openings 133 (e.g., associated with the individual pots 221, FIG. 15). In the illustrated embodiments, the separation features can include a plurality of first partial cuts 135 (e.g., reverse scores and/or other suitable lines of weakening) formed in the underside of the flange panel 131 of the construct 101. In example embodiments, the first partial cuts 135 can be formed in the construct 101 during a die cutting process, cutting the construct 101 from a web of material. In embodiments, the first partial cuts 135 can extend approximately 50% through the thickness of the flange panel 131 of the construct 101 or any suitable distance through the material.

As schematically shown in FIG. 1, the construct 101 further can include a plurality of second partial cuts (e.g., scores and/or other suitable lines of weakening) formed in an upper side (broadly, “first surface” or “upper surface” or “second surface”) of the construct 101. In exemplary embodiments, the second partial cuts 137 can be formed when the package (e.g., the package 215 of FIG. 14) is at least partially formed, such as with the liner 209 and the lid 213 applied to the upper side of the flange panel 131.

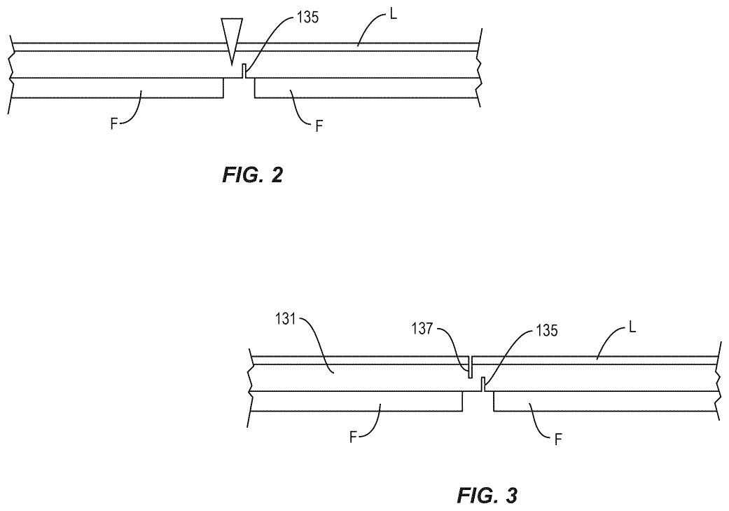

For example, FIG. 2 schematically shows a cross-section of a portion of the package 215 between two of the pots or sections 221, wherein flange portions 253 of the bottom constructs 217 extend along a bottom surface (broadly, “first surface” or “second surface”) of the flange panel 131 and a layer of material L (e.g., representing at least the liner 209 and/or the lid 213 and/or any other suitable polymeric layer/liner and/or other suitable material) extends along a top surface of the flange panel 131. One of the first partial cuts 135 is shown extending from the underside of the flange panel 131 partially through the flange panel 131 between the flange portions 253 (e.g., between two pots 221 of the package 215). As discussed above, the first partial cut 135 may have been formed during die cutting of the construct 101, before the assembly of the package. During a secondary process schematically shown in FIG. 2, a knife K and/or other suitable tool can form a second partial cut 137 (FIG. 3) through the layer L (e.g., through the liner 209 and/or the lid 213) and into the flange panel 131 from the top side of the flange panel 131. FIGS. 1 and 3 schematically show the second partial cut 137 offset from the first partial cut 135 in the plane of the flange panel 131 (e.g., offset in the direction L1 and/or L2). As shown in FIG. 1, the partial cuts 135, 137 in each pair of partial cuts can at least partially converge and/or intersect so as to be in registration at their respective ends.

In embodiments, the separation features could be applied to any suitable package or other construct with parts that are intended to be separated. For example, a die-cut construct (e.g., comprising paperboard and/or other suitable materials) can be formed with a first partial cut on a first side of the construct (e.g., during a die cutting process), a liner material and/or a lid can be applied to the opposing second side of the construct, and a second partial cut can be formed through the liner/lid and into the second side of the construct (e.g., during a secondary process), wherein the first and second partial cuts are offset from one another in the plane of the construct by a suitable distance (e.g., for allowing the construct to remain intact until a user selectively removes one or more portions of the construct at the offset cuts).

All dimensional information presented herein is intended to be illustrative of certain aspects, features, etc., of various embodiments of the disclosure, and is not intended to limit the scope of the disclosure. The dimensions of the blanks, containers, forming tools, features, or any other dimension, can be more or less than what is shown and described in this disclosure without departing from the scope of this disclosure and can be within the listed ranges of dimensions for each feature or outside the listed ranges of dimensions for each feature without departing from the scope of this disclosure.

The blanks according to the present invention can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blanks. The blanks may also be coated with, for example, a moisture barrier layer, on either or both sides of the blanks.

In general, the blanks may be constructed from paperboard having a caliper so that it is heavier and more rigid than ordinary paper. The blank can also be constructed of other materials, such as cardboard, or any other material having properties suitable for enabling the carton to function at least generally as described above. The blanks can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carton embodiments. The term “glue” is intended to encompass all manner of adhesives commonly used to secure carton panels in place.

The foregoing description illustrates and describes various embodiments of the present disclosure. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, and alterations, etc., of the above-described embodiments. Additionally, the disclosure shows and describes only selected embodiments, but various other combinations, modifications, and environments are contemplated and are within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A packaging construct, the packaging construct comprising:
a panel comprising a first surface and an opposing second surface;
at least a layer of material extending along the second surface of the construct;
a first partial cut at least partially extending into the panel from the first surface; and
a second partial cut extending through the layer of material and into the second surface of the panel,
the first partial cut and the second partial cut cooperate to at least partially form a separation feature in the construct for facilitating separation between portions of the construct.

2. The packaging construct of claim 1, wherein the first partial cut and the second partial cut are offset along a plane formed by the panel.

3. The packaging construct of claim 1, wherein the first partial cut and the second partial cut are in at least partial registration through a thickness of the panel.

4. The packaging construct of claim 3, wherein the first partial cut extends at least 50% through the thickness of the panel.

5. The packaging construct of claim 4, wherein the layer of material is a polymeric liner, and the panel comprises paperboard.

6. A package, the package comprising:
a crown, the crown comprising a plurality of separably connected flange panels, each flange panel extending at least partially around an opening, the crown further comprising a plurality of end flaps foldably connected to the respective flange panel and extending into the respective opening;
a plurality of bottom constructs attached to a respective flange panel of the crown to form a base layer, each bottom construct comprising a bottom panel and a plurality of side panels foldably connected to the bottom panel and extending at least partially around an interior of the bottom construct, respective end flaps of the crown attached to respective side panels of the respective bottom construct; and
a liner at least partially overlying the flange panels and the bottom constructs, the liner extending along a second surface of a pair of flange panels of the plurality of flange panels, the second surface opposite an upper surface of the pair of flange panels,
a first partial cut extends into the pair of flange panels from the first surface and a second partial cut extends through the liner and into the second surface of the pair of flange panels from the second surface,
the first partial cut and the second partial cut cooperate to at least partially form a separation feature in the flange panels for facilitating separation between portions of the package.

7. The package of claim 6, further comprising a lid attached to the crown, the lid comprising a plurality of separably connected lid sections, the second partial cut extending into the lid.

8. The package of claim 6, comprising a plurality of separably connected pots, each pot comprising a respective bottom construct, a respective portion of the liner, and a respective lid section.

9. The package of claim 8, wherein the first partial cut and the second partial cut are offset along a plane formed by the panel.

10. The package of claim 9, wherein the first partial cut and the second partial cut are in at least partial registration through a thickness of the panel.

11. The package of claim 10, wherein the first partial cut extends at least 50% through the thickness of the panel.

12. The package of claim 11, wherein the layer of material is a polymeric liner, and the panel comprises paperboard.

13. A method of forming a package, the method comprising:
obtaining a crown blank, the crown blank comprising a plurality of separably connected flange panels, each flange panel extending at least partially around an opening, the crown further comprising a plurality of end flaps foldably connected to the respective flange panel and extending into the respective opening;
obtaining a bottom blank, the bottom blank comprising a bottom panel and a plurality of side panels foldably connected to the bottom panel;
obtaining a liner;
forming a crown from the crown blank;
forming a plurality of bottom constructs from the bottom blank such that the plurality of side panels extends at least partially around an interior of the respective bottom construct;
attaching respective end flaps of the crown to respective side panels of a respective bottom construct to form a base layer;
at least partially overlying the liner on the flange panels and the bottom constructs such that the liner extends along a second surface of a pair of flange panels of the plurality of flange panels, the second surface opposite an upper surface of the pair of flange panels;
forming a first partial cut extending into the pair of flange panels from the first surface;
forming a second partial cut extending through the liner and into the second surface of the pair of flange panels from the second surface,
the first partial cut and the second partial cut cooperate to at least partially form a separation feature in the flange panels for facilitating separation between portions of the package.

14. The package of claim 13, further comprising a lid attached to the crown, the lid comprising a plurality of separably connected lid sections, the second partial cut extending into the lid.

15. The package of claim 13, comprising a plurality of separably connected pots, each pot comprising a respective bottom construct, a respective portion of the liner, and a respective lid section.

16. The package of claim 15, wherein the first partial cut and the second partial cut are offset along a plane formed by the panel.

17. The package of claim 16, wherein the first partial cut and the second partial cut are in at least partial registration through a thickness of the panel.

18. The package of claim 17, wherein the first partial cut extends at least 50% through the thickness of the panel.

19. The package of claim 18, wherein the layer of material is a polymeric liner, and the panel comprises paperboard.
